(19) United States
(12) Patent Application Publication
(10) Pub. No.: US 2022/0198688 A1
(43) Pub. Date: Jun. 23, 2022

(54) LASER COARSE REGISTRATION METHOD, DEVICE, MOBILE TERMINAL AND STORAGE MEDIUM

(71) Applicant: MEGVII (BEIJING) TECHNOLOGY CO., LTD., Beijing (CN)

(72) Inventors: Xizhen XIAO, Beijing (CN); Xiao LIU, Beijing (CN)

(21) Appl. No.: 17/603,838

(22) PCT Filed: Apr. 2, 2020
(86) PCT No.: PCT/CN2020/082981

§ 371 Date: Oct. 14, 2021

(30) Foreign Application Priority Data
Apr. 17, 2019 (CN) 201910310449.0

(51) Int. Cl. G06T 7/33; G06T 7/73; G06V 10/82; G06V 10/75; G06V 10/44; G05D 1/02

(52) U.S. Cl. CPC G06T 7/33; G06T 7/73; G06V 10/82; G06T 2207/20084; G06V 10/443; G05D 1/024; G05D 1/0221; G06V 10/751

(57) ABSTRACT

Provided are a laser coarse registration method, device, mobile terminal and storage medium, the method comprises: determining the position information of obstacles around a robot; converting the position information of the obstacle into an obstacle image; acquiring map data of a pre-established probability map; converting the map data into a map image; carrying out matching processing on the obstacle image and the map image through a convolutional neural network to obtain a coarse registration position of the robot on the map image. The laser coarse registration method carries out convolution matching processing on the obstacle image and the map image obtained by the robot through the convolutional neural network, achieves the coarse registration of laser data collected by the robot and the probability map, the registration range is expanded, and the precision of coarse registration is improved.

The present application claims the priority of Chinese patent application, filed on Apr. 17, 2019, with the filing number of 201910310449.0, the whole content of which is incorporated herein by reference, as a part of the present application.

### TECHNICAL FIELD

Embodiments of the present application relate to a laser coarse registration method, device, mobile terminal and storage medium.

### BACKGROUND ART

With the development of mobile robots and the continuous improvement of their performance, people's demand for robots has gradually increased. For example, drones, sweeping robots, 3D printing robots, surveillance robots, etc. have greatly facilitated people's lives. Mobile robots need to perceive and model the surrounding environment for realizing autonomous path planning and navigation. It is the most commonly used that the simultaneous localization and mapping (SLAM) algorithm, which is based on ladar, is used. As for the simultaneous localization and mapping (SLAM) algorithm based on ladar, during a mobile robot is moving, the laser is irradiated on an obstacle, the data is obtained by the laser being returned, and the data is matched with the map, so as to calculate the pose of the mobile robot on the map. At the same time, the map can be updated in turn through the information of the laser, that is, an incremental map is built to realize the autonomous positioning and navigation of the mobile robot. In this way, as the robot moves, the map is theoretically updated and enriched continuously, and the positioning of the mobile robot will become more precise increasingly.

### SUMMARY

The technical problem to be solved by the embodiments of the present application is to provide a laser coarse registration method, device, mobile terminal, and storage medium, so as to solve the technical problem that, in the prior art, the violence matching in the coarse registration increases the computational complexity, which leads to the reduced accuracy of the coarse registration pose.

Correspondingly, at least one embodiment of the present application also provides a laser coarse registration device, a mobile terminal, and a storage medium for ensuring implementation and application of the above method.

In order to solve the above problem, the present disclosure is implemented at least through the following technical solution.

In the first aspect, provided is a laser coarse registration method, the method comprises:

determining position information of an obstacle around a robot;

converting the position information of the obstacle into an obstacle image; obtaining map data of a pre-established probability map;

converting the map data into a map image; and making the obstacle image and the map image subjected to a matching processing through a convolutional neural network, so as to obtain a coarse registration pose of the robot on the map image.

Optionally, the converting the position information of the obstacle into an obstacle image comprises:

performing conversion processing on the position information of the obstacle to obtain pixel values of the obstacle image;

determining a point whose the pixel value is a first pixel value, as an obstacle point on the obstacle image, and determining points, the pixel value of each of which is a second pixel value, as non-obstacle points on the obstacle image; and

marking the obstacle point and non-obstacle points on the obstacle image.

Optionally, the converting the map data into a map image comprises:

performing a converting processing on the map data according to a preset probability threshold, to obtain the pixel values of the map image;

determining a point whose the pixel value is a first pixel value, as an obstacle point on the map image, and determining points, the pixel value of each of which is a second pixel value, as non-obstacle points on the map image; and

marking the obstacle point and non-obstacle points on the map image.

Optionally, the making the obstacle image and the map image subjected to a matching processing through a convolutional neural network so as to obtain a coarse registration pose of the robot on the map image comprises:

inputting respectively the obstacle image and the map image to a laser convolutional neural network LaserCNN layer of the convolutional neural network to be subjected to a convolution matching processing, to obtain a first characteristic matrix and a second characteristic matrix;

inputting the first characteristic matrix and the second characteristic matrix to a pose layer of the convolutional neural network to be subjected to a superposition and flattening processing, to obtain a one-dimensional feature vector; and

performing a full connection processing of three dimensions on the one-dimensional feature vector, to obtain a three-dimensional feature vector, and inputting the obtained three-dimensional feature vector into a full connection layer for being processed, to obtain one three-dimensional feature vector, wherein the one three-dimensional feature vector is the coarse registration pose of the robot on the map image.

Optionally, the method further comprises:

using a non-linear optimization registration method to perform precise registration on the coarse registration pose of the robot on the map image, to obtain a precise pose of the robot in the probability map; and

updating the probability map according to the precise pose.

Optionally, the updating the probability map according to the precise pose Zo comprises:

calculating a position of an obstacle around the robot on the probability map, according to the precise pose;

judging, according to the position, whether a corresponding point on the probability map is an obstacle point, wherein if yes, a probability value of the corresponding point on the probability map is updated by a preset hit probability value, and if no, a probability value of a corresponding point on the probability map is updated by a preset missing probability value.

In the second aspect, provided is a laser coarse registration device, comprising:

a first determination module, configured to determine position information of an obstacle around a robot; and

a first conversion module, configured to convert the position information of the obstacle into an obstacle image;

an acquisition module, configured to acquire map data of a pre-established probability map;

a second conversion module, configured to convert the map data into a map image; and

a matching processing module, configured to perform a matching processing on the obstacle image and the map image through a convolutional neural network, to obtain a coarse registration pose of the robot on the map image.

Optionally, the first conversion module comprises:

a first conversion processing module, configured to perform a conversion processing on the position information of the obstacle, to obtain the pixel values of the obstacle image;

a second determination module, configured to determine a point whose pixel value is a first pixel value, as an obstacle point on the obstacle image, and determine points, a pixel value of each of which is a second pixel value, as non-obstacle points on the obstacle image; and a first marking module, configured to mark the obstacle point and the non-obstacle points on the obstacle image.

Optionally, the second conversion module comprises:

a second conversion processing module, configured to perform a conversion processing on the map data according to a preset probability threshold, to obtain pixel values of the map image;

a third determination module, configured to determine a point whose pixel value is a first pixel value, as an obstacle point on the map image, and determine points, a pixel value of each of which is a second pixel value, as non-obstacle points on the map image; and

a second marking module, configured to mark the obstacle image point and the non-obstacle image points on the map image.

Optionally, the matching processing module comprises:

a first convolution processing module, configured to respectively input the obstacle image and the map image into the laser convolution neural network LaserCNN layer of the convolution neural network to perform convolution matching processing, to obtain the first characteristic matrix and the second characteristic matrix;

a second convolution processing module, configured to input the first characteristic matrix and the second characteristic matrix to the pose layer of the convolutional neural network to perform superposition and flattening processing, to obtain a one-dimensional feature vector; and

a full connection processing module, configured to perform three-dimensional full connection processing on the one-dimensional feature vector, and input the obtained vector to a last full connection layer for processing, to obtain one three-dimensional feature vector, the one three-dimensional feature vector is a coarse registration pose of the robot on the map image.

Optionally, the device further comprises:

a fine registration processing module, configured to perform precise registration on the coarse registration pose of the robot on the map image by using a non-linear optimization registration method, to obtain a precise pose of the robot in the probability map; and

an update module, configured to update the probability map according to the precise pose.

Optionally, the update module comprises:

a position calculation module, configured to calculate a position of an obstacle around the robot on the probability map according to the precise pose;

a judgment module, configured to judge whether a corresponding point on the probability map is an obstacle point according to the position;

a first position update module, configured to update a probability value of the corresponding point on the probability map by a preset hit probability value, when the judgment module determines that the corresponding point on the probability map is an obstacle point; and

a second position update module, configured to update a probability value of the corresponding point on the probability map by a preset missing probability value, when the judgment module determines that the corresponding point on the probability map is a non-obstacle point.

In the third aspect, provided is a mobile terminal, comprising: a memory, a processor, and a computer program stored on the memory and capable of running on the processor, wherein the computer program, when being executed by the processor, realizes steps of the laser coarse registration method mentioned above.

In the fourth aspect, provided is a computer-readable storage medium, wherein a computer program is stored on the computer-readable storage medium, and when being executed by a processor, the computer program realizes steps in the laser coarse registration method mentioned above.

Compared with the prior art, at least one embodiment of the present application comprises the following advantages.

In the embodiments of the present application, after determining the position information of an obstacle around the robot, the position information of the obstacle is converted into an obstacle image; and the map data of the probability map is obtained, and the map data is converted into a map image; and then the matching processing is performed on the obstacle image and the map image through a convolutional neural network to obtain the coarse registration pose of the robot on the map image. That is to say, in the embodiments of the present application, the obstacle image and the map image obtained by the robot are subjected to convolution matching processing (that is, deep learning) through the convolutional neural network, and the coarse registration of the laser data collected by the robot and the probability map is realized. That is, the computational complexity caused by the violence matching can be avoided by the coarse registration of the convolutional neural network, the range of the registration is enlarged, and the accuracy of the coarse registration is improved.

It should be understood that the above general description and the following detailed description are only exemplary and explanatory, and cannot limit the present application.

### BRIEF DESCRIPTION OF DRAWINGS

In order to explain the technical solutions of the embodiments of the present application more clearly, the drawings required to be used in the description of the embodiments of the present application will be briefly introduced as follows.

Obviously, the drawings in the following description are only showing some embodiments of the present application. For those ordinarily skilled in the art, without creative labor, other drawings can be obtained based on these drawings.

FIG. 1 is a flowchart of a laser coarse registration method provided by an embodiment of the present application;

FIG. 2 is a schematic structural diagram of a LaserCNN layer in a convolutional neural network provided by an embodiment of the present application;

FIG. 3 is a schematic structural diagram of a pose layer in a convolutional neural network provided by an embodiment of the present application;

FIG. 4 is another flowchart of a laser coarse registration method according to an embodiment of the present application;

FIG. 5 is a schematic structural diagram of a laser coarse registration device provided by an embodiment of the present application;

FIG. 6 is a schematic structural diagram of a first conversion module provided by an embodiment of the present application;

FIG. 7 is a schematic structural diagram of a second conversion module provided by an embodiment of the present application;

FIG. 8 is a schematic structural diagram of a matching processing module provided by an embodiment of the present application;

FIG. 9 is another schematic structural diagram of a laser coarse registration device provided by an embodiment of the present application; and

FIG. 10 is a schematic structural diagram of an update module provided by an embodiment of the present application.

### DETAILED DESCRIPTION OF EMBODIMENTS

In order to make the above objectives, features and advantages of the present application more obvious and understandable, the present disclosure will be further described in detail below in combination with the drawings and specific embodiments.

The technical solutions in the embodiments of the present application will be clearly and completely described below with reference to the drawings in the embodiments of the present application. Obviously, the described embodiments are part of the embodiments of the present application, not all of the embodiments. Based on the embodiments of the present application, all other embodiments, which are obtained by those ordinarily skilled in the art without creative work, shall fall within the protection scope of the present application.

In practical application, due to the limitation of the map representation and non-linear solver, only in the case that the non-linear optimization initial value is close to the true value, the registration can be successful. And the non-linear optimization registration method has a strict requirement on the initial value. Typically, discrete poses are used for the coarse matching. In the coarse matching, the possible poses are discretized first, then the violence matching is performed, and finally, non-linear optimization is performed according to the result of violence matching, to calculate the pose. Because the violence matching in the coarse matching increases the computational complexity, the relatively small matching range is caused. Thereby, the accuracy of the calculated pose is reduced. Therefore, the inventor noticed that the technical problem to be solved at present is how to improve the accuracy of the coarse registration of the laser and the map while reducing the complexity of matching calculation.

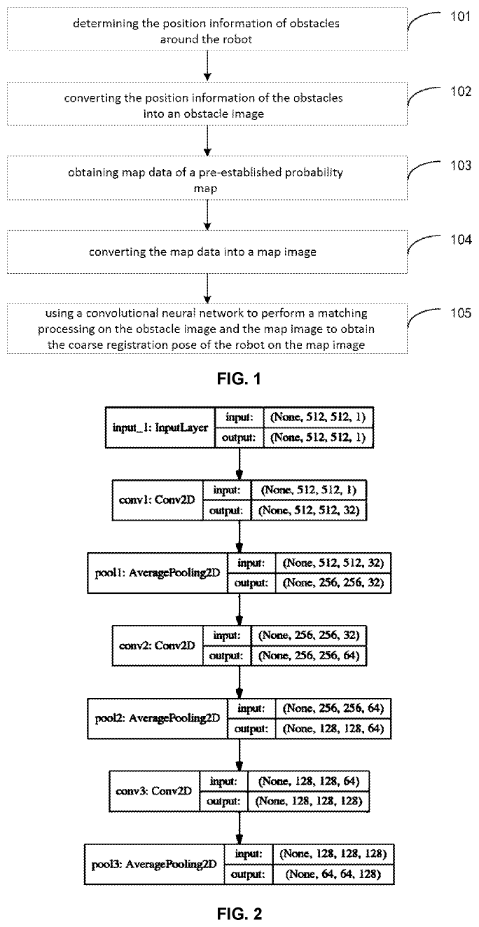

Referring to FIG. 1, which is a flowchart of a laser coarse registration method according to an embodiment of the present application, and the method is applicable to a robot and may specifically comprise the following steps.

Step 101: determining the position information of obstacles around the robot.

In this step, the robot first collects, through its own laser radar, the data of multiple beams of laser, and then determines the position information of the obstacles through the laser data.

Supposing that the data of N beams of laser is collected by the robot, with each beam of laser being at the angle of θᵢ, and the depth value of each laser beam is dᵢ, where i is a natural number from 1 to N.

In this embodiment, the laser data is used to determine the position information of the robot with respect to the obstacle. The position information of the obstacle is represented by multiple coordinate points, which can be represented by coordinate points (xᵢ, yᵢ), where the values of xᵢ and yᵢ can be determined by the formula xᵢ=cos(θᵢ)dᵢ and yᵢ=sin(θᵢ)dᵢ.

Step 102: converting the position information of the obstacles into an obstacle image.

In this step, first, the position information of the obstacles is converted to obtain the pixel value of the obstacle image, and the position information of the obstacles is converted into the pixel value of the obstacle image. The conversion formula is:

Image(scale*xᵢ+x₀,scale*yᵢ+y₀)=255

where, in the formula, 255 is the first pixel value, image represents the obstacle image, scale is the scaling factor for the obstacle image, the scaling factor can be set according to the measurement range of the laser data, and the values of x₀ and y₀ are determined based on the obstacle image size, x₀ is half of the width of the obstacle image, y₀ is half of the length of the obstacle image, and the values of other pixels are 0, which is the second pixel value.

Secondly, the points whose pixel values are the first pixel value are determined as an obstacle points on the obstacle image, and the points whose pixel values are the second pixel value are determined as the non-obstacle points on the non-obstacle image.

Finally, the obstacle points and the non-obstacle points on the obstacle image are marked.

Step 103: obtaining map data of a pre-established probability map.

The probability map in this step is a probability map in the pre-established world coordinate system, and the probability map is built in the robot in advance.

Step 104: converting the map data into a map image.

In this step, first, according to a preset probability threshold, the map data is converted as follows to obtain the pixel value of the corresponding pixel on the map image.

If the preset probability threshold in the probability map M(x, y)>0.5, the coordinate conversion process is performed according to the formula Image′(scale′*x, scale′*y)=255 (i.e., the first pixel value), that is, the map data is converted into the corresponding pixel value according to the above formula, wherein image′ represents a map image, scale′ is a scaling factor for the obstacle image, the scaling factor can be set according to the measurement range of the laser data, and the pixel values of other points are 0 (that is, the second pixel value).

Here, it should be noted that the expressions, Image′ and scale′, are used in this formula, which is only for the purpose of distinguishing them from the Image and scale in the above formula.

Secondly, the points whose pixel values are the first pixel value are determined as obstacle points on the map image, and the points whose pixel values are the second pixel value are determined as non-obstacle points on the map image.

That is, in this embodiment, after the map data is converted into the corresponding pixel values on the map image, each pixel value is judged, and the point whose pixel value is the first pixel value is determined as an obstacle point on the map image and the point whose pixel value is the second pixel value is determined as a non-obstacle point on the map image.

Finally, the obstacle points and the non-obstacle points on the map image are marked, and a map image comprising the obstacle points and the non-obstacle points is obtained.

Step 105: using a convolutional neural network to perform a matching processing on the obstacle image and the map image to obtain the coarse registration pose of the robot on the map image.

Here, the matching processing in this step comprises the follows.

First, the obstacle image and the map image are input into the LaserCNN layer of the convolutional neural network, respectively, to perform convolution matching processing to obtain the first characteristic matrix and the second characteristic matrix; secondly, the first characteristic matrix and the second characteristic matrix are input to the Pose layer of the convolutional neural network for being subjected to superposition and flattening processing, so as to obtain a one-dimensional feature vector; and finally, the one-dimensional feature vector is sequentially subjected to a three-dimensional full connection processing, to obtain a three-dimensional feature vector, and the three-dimensional feature vector is input to a full connection layer for being processed, to obtain one three-dimensional feature vector, wherein the one three-dimensional feature vector is the coarse registration pose of the robot on the map image.

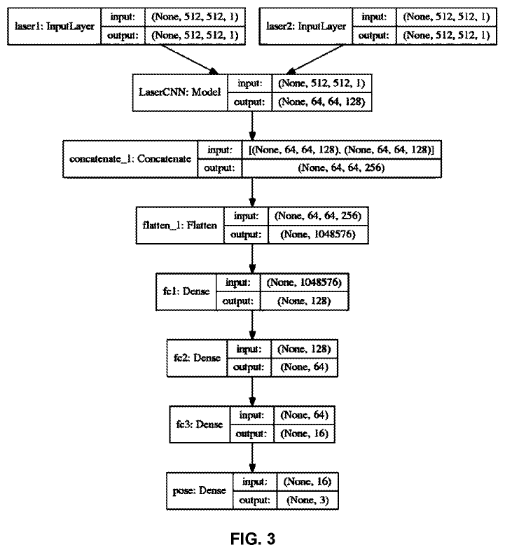

In this embodiment, a laser frame being aligned to a map (Scan2Map) network is taken as an example of the convolutional neural network. The Scan2Map network comprises a laser convolutional neural networks (LaserCNN) layer and a pose layer. Here, a schematic diagram of the LaserCNN layer is as shown in FIG. 2, that is, FIG. 2 is the schematic structural diagram of the LaserCNN layer in a convolutional neural network provided by an embodiment of the present application. The schematic diagram of the pose layer is shown in FIG. 3, which is a schematic structural diagram of a pose layer in a convolutional neural network provided by an embodiment of the present application.

Here, as shown in FIG. 2, the LaserCNN layer is divided into L1, L2, L3, L4, L5, and L6. The L1 (i.e. conv1) is composed of 32 3×3 convolution kernels, being a convolution layer with a step size of 1. The L2 (i.e. pool1) is an average pooling layer with the size of 2. The L3 (i.e. conv2) is composed of 64 3×3 convolution kernels, being the convolution layer of the step size of 1. The L4 (i.e. pool2) is the average pooling layer with the size of 2. The L5 (i.e. conv3) is composed of 128 3×3 convolution kernels, being the convolution layer with a step size of 1. The L6 (i.e. pool3) is the average pooling layer with the size of 2.

Here, as shown in FIG. 3, the pose layer is divided into L1, L2, L3, L4, L5 and L6. In the L1 layer, the outputs of the two LaserCNN layers (i.e. laser1 and laser2) are superimposed (i.e. concatenate). In the L2 layer, the output of L1 is flattened, to form a one-dimensional layer (i.e. Flattern). The L3 is a full connection layer with a dimension of 128 (i.e. fc1: Dense). The L4 is a full connection layer with a dimension of 64 (i.e. fc2: Dense). The L5 is a full connection layer with a dimension of 16 (i.e. fc3: Dense). The L6 (i.e. pose: Dense) outputs 3 vectors, representing the transformation (x, y, theta) of the two inputs, laser1 and laser2.

For ease of understanding, an illustration is made, referring to an application example as below. In particular, FIG. 3 is referred to.

Assuming that two radar images, laser1 and laser2, of the candidate reference object with a resolution of 512*512 are currently input to the convolutional neural network, the matrix sent to the convolutional neural network is: 512*512*1 (*1, because the radar image is of a single channel, it is represented by *1). After the two lasers are output by the same LaserCNN layer, each of them obtains a 64×64×128 characteristic matrix. It should be noted that, in FIG. 3, a LaserCNN layer: Model is used as an example.

In the Pose layer, firstly the two characteristic matrices are concatenated to form 64×64×256, and then are flattened into a one-dimensional feature vector of 1048576 (i.e., 64×64×256=1048576), and then after a full connection (i.e., fc1:Dense, fc2:Dense and fc3:Dense) with three dimensions, respectively being 128, 64, 16, is performed, a 3-dimensional vector is directly obtained in the last full connection layer (i.e. pose:Dense), which represents that the two inputs, laser1 and laser2, after being subjected to the convolutional neural network, are transformed to the coarse pose, expressed by (x, y, theta).

Of course, if the coarse pose (x, y, theta) output after being subjected to the convolutional neural network uses (x_{c}, y_{c}, θ_{c}) as an example, then after the coarse pose is obtained, a post-processing is needed for obtaining the coarse registration pose of (x_{c}/scale-x₀, y_{c}/scale-y₀, θ_{c}). That is, the coordinate point needs to be correspondingly reduced in the subsequent process for times in the number equal to that of times for which the coordinate point is enlarged in the early-stage process.

In the embodiment of the present application, after determining the position information of the obstacle around the robot, the position information of the obstacle is converted into an obstacle image; and the map data of the probability map is obtained, and the map data is converted into a map image, and afterwards, the matching processing is performed on the obstacle image and the map image by means of a convolutional neural network to obtain the coarse registration pose of the robot on the map image. That is to say, in the embodiment of the present application, the obstacle image and map image obtained by the robot are subjected to convolution matching processing (that is, deep learning) through the convolutional neural network, and the coarse registration of the laser data collected by the robot and the probability map is realized. That is, the computational complexity caused by the violent matching can be avoided by the coarse registration of the convolutional neural network, the scope of the registration is enlarged, and the accuracy of the coarse registration is improved.

Optionally, another embodiment is provided, and this embodiment is based on the above-mentioned embodiment.

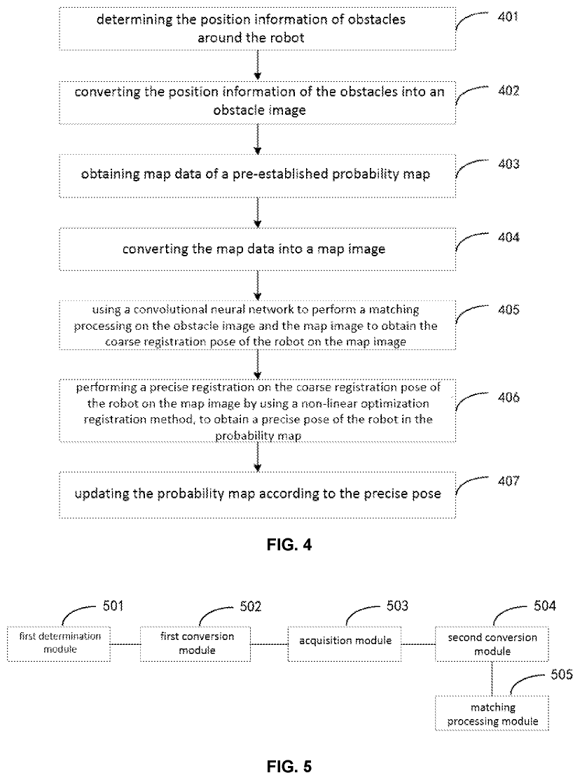

Also referring to FIG. 4, which is another flowchart of a laser coarse registration method provided by an embodiment of the present application. In this embodiment, on the basis of the above-mentioned embodiment in FIG. 1, it is also possible to perform a non-linear optimization registration to the coarse registration pose, so as to obtain a precise pose, and the probability map is automatically updated according to the precise pose. The method specifically comprises:

Step 401: determining the position information of the obstacle around the robot;

Step 402: converting the position information of the obstacle into an obstacle image;

Step 403: obtaining map data of a pre-established probability map;

Step 404: converting the map data into a map image;

Step 405: performing a matching processing on the obstacle image and the map image by means of a convolutional neural network, to obtain the coarse registration pose of the robot on the map image.

In the above, Step 401 to Step 405 are the same as Step 101 to Step 105, which may be referred to the above-mentioned for details, not being repeated here.

Step 406: performing a precise registration on the coarse registration pose of the robot on the map image by using a non-linear optimization registration method, to obtain a precise pose of the robot in the probability map.

In this step, the process of using a registration method based on non-linear optimization to precisely register the obtained coarse registration pose comprises the followings.

First, the probability sum, for the situation in which the obstacle detected by the laser data corresponds to that in the probability map, is calculated. When the obstacle in the laser data is fully corresponding to the obstacle in the probability map, the probability sum should be largest.

Secondly, the coarse registration pose is continuously optimized, and when the obtained probability sum is largest, the laser data and the probability map are successfully registered.

Third, the probability map in SLAM based on lidar is represented by a common probability grid. The map is modeled as discrete grids, wherein each grid is assigned a probability value of 0 to 1. The closer the probability value is to 1, the greater the probability that the grid is an obstacle is. The closer the probability value is to 0, the greater the probability that the grid is not an obstacle is.

Then, the lidar sensor can indirectly obtain the distance from the robot to the obstacle, by recording the time difference between the laser being launched and the laser being returned after encountering an obstacle.

Finally, the pose of the robot on the probability map can be obtained by registering the obstacle measured by the laser data and the probability map.

It should be noted that, in this embodiment, the obtained coarse registration pose is precisely registered, based on the non-linear optimization registration method, which is a well-known technique and will not be described again.

Step 407: updating the probability map according to the precise pose.

In this step, firstly, the position of the obstacle around the robot on the probability map is calculated according to the precise pose.

Then, it is determined whether the corresponding point in the probability map is an obstacle according to the position, that is, it is determined whether the corresponding point in the probability map has an obstacle scanned by the robot this time, wherein if yes, the probability value of the corresponding point on the probability map is updated through a preset hit probability value; and if no, the probability value of the corresponding point on the probability map is updated through the preset missing probability value.

That is to say, in this embodiment, as for the update of obstacles (which can be understood as an obstacle point), the obstacle point is the probability grid corresponding to (cos(θ_{f})xᵢ+x_{f}, sin(θ_{f})yᵢ+y_{f}). In this embodiment, the obstacle point on the map can be updated by the following formula, which is:

odds(M_{new})=odds(M_{old})odds(Pₕᵢₜ).

Here, it can be known from the above formula that the original obstacle's occupancy ratio odds(M_{old}) is multiplied by the occupancy ratio odds(Pₕᵢₜ) of the obstacle hit by the laser data, so as to get the occupancy ratio odds(M_{new}) of a new obstacle.

In the formula, Pₕᵢₜ is the preset hit probability, that is, the preset probability that the laser data hits the obstacle, wherein odds (Pₕᵢₜ) represents the occupancy ratio of the obstacle, referred to as odds(P) for short, which is that the probability of the obstacle is compared with the probability of the non-obstacle, which can be specifically set by the following formula, odds

$$( P ) = \frac{P}{1 - P}$$

where P is the probability of the obstacle.

The update of the non-obstacle point is made in such a way that the non-obstacle points form a line segment from the origin of laser data to cos(θf)xᵢ+x_{f}, sin(θf)yᵢ+y_{f}). Specifically, it can be updated by the following formula, which is:

odds(M_{new})=odds(M_{old})odds(Pₘᵢₛₛ)

where Pₘᵢₛₛ is the preset missing probability, that is, the preset probability that the laser data does not hit an obstacle; and odds (Pₘᵢₛₛ) represents the non-obstacle occupancy ratio, that is, the ratio of the probability of non-obstacle to the probability of obstacle.

In the embodiment of the present application, after determining the position information of the obstacle around the robot, the position information of the obstacles is converted into an obstacle image; and the map data of the probability map is obtained, and the map data is converted into a map image, and afterwards the matching processing is performed on the obstacle image and the map image through a convolutional neural network to obtain the coarse registration pose of the robot on the map image. That is to say, in the embodiment of the present application, the obstacle image obtained by the robot and the map image are subjected to the convolution matching processing (that is, deep learning) through the convolutional neural network, and the coarse registration of the laser data collected by the robot and the probability map is realized. That is, the computational complexity of the violent matching can be avoided by the coarse registration of the convolutional neural network, the scope of the registration is enlarged, and the accuracy of the coarse registration is improved.

It should be noted that for method embodiments, for the sake of simple description, each of them is expressed as a combination of a series of actions, but those skilled in the art should understand that the embodiments of the present application are not limited to the described sequence of actions, because according to the embodiments of the present application, certain steps may be performed in other order or simultaneously. Secondly, those skilled in the art should also understand that the embodiments described in the specification are all optional embodiments, and the actions involved are not necessarily required by the embodiments of the present application.

Referring to FIG. 5, which is a schematic structural diagram of a laser coarse registration device provided by an embodiment of the present application. The device specifically comprises: a first determination module 501, a first conversion module 502, an acquisition module 503, a second conversion module 504, and a matching processing module 505, wherein

the first determination module 501 is configured to determine the position information of the obstacles around the robot;

the first conversion module 502 is configured to convert the position information of the obstacles into an obstacle image;

the acquisition module 503 is configured to obtain map data of a pre-established probability map;

the second conversion module 504 is configured to convert the map data into a map image; and

the matching processing module 505 is configured to perform the matching processing on the obstacle image and the map image through a convolutional neural network, to obtain the coarse registration pose of the robot on the map image.

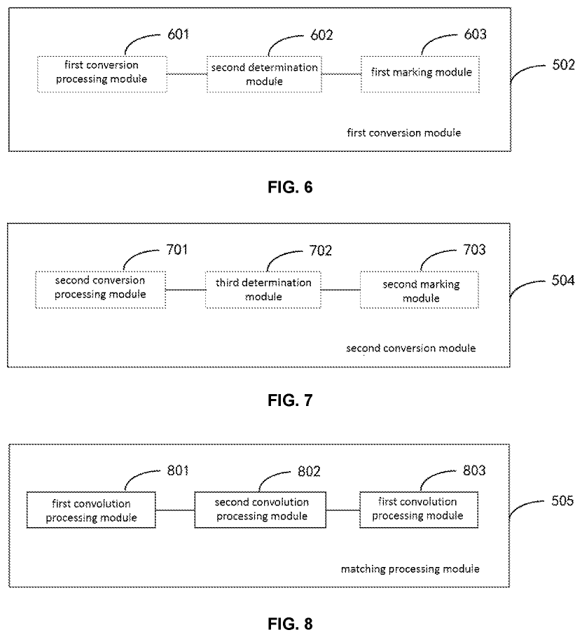

Optionally, in another embodiment, this embodiment is based on the foregoing embodiment. The first conversion module 502 comprises: a first conversion processing module 601, a second determination module 602, and a first marking module 603, with the schematic structural diagram shown in FIG. 6, wherein

the first conversion processing module 601 is configured to perform a conversion processing on the position information of the obstacles to obtain a corresponding pixel value;

the second determination module 602 is configured to determine the points whose pixel values are the first pixel value as obstacle points on the obstacle image, and determine the points whose pixel values are the second pixel value as the non-obstacle points on the obstacle image; and the first marking module 603 is configured to mark obstacle points and non-obstacle points on the obstacle image.

Optionally, in another embodiment, this embodiment is based on the foregoing embodiment. The second conversion module 504 comprises: a second conversion processing module 701, a third determination module 702, and a second marking module 703, with the schematic structural diagram shown in FIG. 7, wherein

the second conversion processing module 701 is configured to perform a conversion processing on the map data according to a preset probability threshold to obtain the pixel values of the map image;

the third determination module 702 is configured to determine the points whose pixel values are the first pixel value as obstacle points on the map image, and determine the points whose pixel values are the second pixel value as the non-obstacle points on the map image; and

the second marking module 703 is configured to mark, on the map image, the points of the obstacle image and the points of the non-obstacle image.

Optionally, in another embodiment, this embodiment is based on the foregoing embodiment. The matching processing module 505 comprises: a first convolution processing module 801, a second convolution processing module 802, and a full connection processing module 803, with the schematic structural diagram shown in FIG. 8, wherein

the first convolution processing module 801 is configured to input respectively the obstacle image and the map image into the laser convolution neural network LaserCNN layer of the convolution neural network to perform the convolution matching processing, to obtain a first characteristic matrix and a second characteristic matrix;

the second convolution processing module 802 is configured to input the first characteristic matrix and the second characteristic matrix to the Pose layer of the convolutional neural network to perform a superposition and flattening processing to obtain a one-dimensional feature vector; and

the full connection processing module 803 is configured to perform three-dimensional full connection processing on the one-dimensional feature vector, and input the obtained vector to the last full connection layer for being processed, to obtain one three-dimensional feature vector. The one three-dimensional feature vector is the coarse registration pose of the robot on the map image.

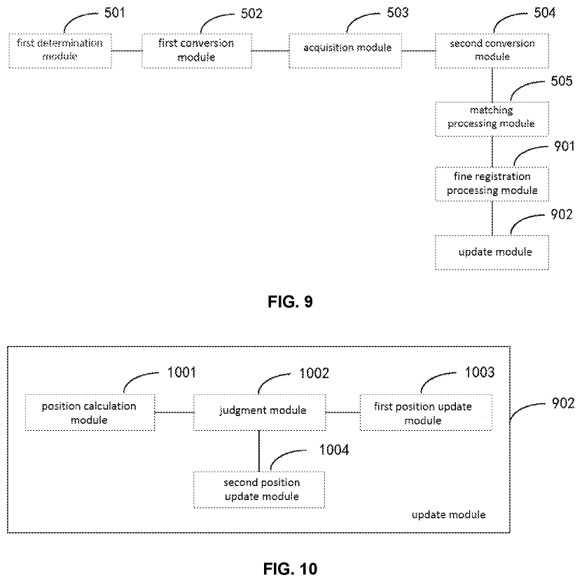

Optionally, in another embodiment, this embodiment is based on the above-mentioned embodiment. The device may further comprise: a fine registration processing module 901 and an update module 902, with the schematic structural diagram shown in FIG. 9. FIG. 9, as an example, is on the basis of the embodiment in FIG. 5, wherein

the fine registration processing module 901 is configured to precisely register the coarse registration pose of the robot on the map image by using a non-linear optimization registration method to obtain the precise pose of the robot in the probability map; and

the update module 902 is configured to update the probability map according to the precise pose.

Optionally, in another embodiment, this embodiment is based on the foregoing embodiment. The update module 902 comprises: a position calculation module 1001, a judgment module 1002, a first position update module 1003, and a second position update module 1004, with the schematic structural diagram shown in FIG. 10, wherein

the position calculation module 1001 is configured to calculate the position of the obstacle around the robot on the probability map according to the precise pose;

the judging module 1002 is configured to judge whether the corresponding point on the probability map is an obstacle point according to the position;

the first position update module 1003 is configured to update the probability value of the corresponding point on the probability map through a preset hit probability value, when the judgment module determines that the corresponding point on the probability map is an obstacle point; and

the second position update module 1004 is configured to update the probability value of the corresponding point on the probability map through a preset missing probability value, when the judgment module determines that the corresponding point on the probability map is an non-obstacle point.

The various embodiments in this specification are described in a progressive manner. Each embodiment focuses on the differences from other embodiments, and the same or similar parts between the various embodiments can be referred to each other.

In the embodiment of the present application, through the deep learning method, using the corresponding images obtained after conversion of the obstacle position and the probability map, the coarse matching is performed to calculate the pose of the robot, which solves the problem that the violence matching in the coarse matching in the prior art causes the computational complexity, the scope of registration is expanded and the accuracy of coarse registration is improved.

Optionally, the embodiment of the present application further provides a mobile terminal, comprising: a memory, a processor, and a computer program stored on the memory and capable of running on the processor. The computer program, when being executed by the processor, realizes the various processes of the embodiments of the laser coarse registration method mentioned above, and achieves the same technical effect. Details are not repeated here, avoiding repetition.

The embodiment of the present application also provides a non-instantaneous computer readable storage medium, and a computer program is stored on the computer readable storage medium. The computer program, when being executed by the processor, realizes the various processes of the embodiments of the laser coarse registration method mentioned above, and achieves the same technical effect. Details are not repeated here, avoiding repetition, wherein the computer readable storage medium is, such as read-only memory (ROM for short), random access memory (RAM for short), magnetic disk, or optical disk, etc.

Those skilled in the art should understand that the embodiments of the present application may be provided as methods, devices, or computer program products. Therefore, the embodiments of the present application may adopt the form of a complete hardware embodiment, a complete software embodiment, or an embodiment combining software and hardware. Moreover, the embodiments of the present application may adopt the form of the computer program product which is implemented on one or more computer-usable storage medium (comprising but not limited to the disk storage, CD-ROM, optical storage, etc.) containing computer-usable program codes.

The embodiments of the present application are described with reference to the flowcharts and/or block diagrams of the methods, terminal devices (systems), and computer program products according to the embodiments of the present application. It should be understood that each process and/or block in the flowchart and/or block diagram, and the combination of processes and/or blocks in the flowchart and/or block diagram can be realized by computer program instructions. These computer program instructions can be provided to the processors of general-purpose computers, special-purpose computers, embedded processing devices, or other programmable data processing terminal equipment, to form a machine, so that by means of the instructions executed by the processor of the computer or other programmable data processing terminal equipment, a device for realizing the functions specified in one or more processes in the flowchart and/or one or more blocks in the block diagram is formed.

These computer program instructions can also be stored in a computer-readable memory that can guide a computer or other programmable data processing terminal equipment to work in a specific manner, so that the instructions stored in the computer-readable memory form a finished product comprising the instruction device. The instruction device implements the functions specified in one or more processes in the flowchart and/or one or more blocks in the block diagram.

These computer program instructions can also be loaded on a computer or other programmable data processing terminal equipment, so that a series of operation steps are executed on the computer or other programmable terminal equipment, to achieve the processing implemented by the computer, so that the instructions executed on the computer or other programmable terminal equipment provide steps for implementing functions specified in one or more processes in the flowchart and/or one or more blocks in the block diagram.

Although the optional embodiments of the embodiments of the present application have been described, those skilled in the art can make additional changes and modifications to these embodiments once they learn the basic creative concept. Therefore, the appended claims are intended to be interpreted as comprising the optional embodiments and all changes and modifications falling within the scope of the embodiments of the present application.

Finally, it should be noted that, in the present application, the relationship terms, such as first and second, are only used to distinguish one entity or operation from another entity or operation, and do not necessarily require or imply these entities or operations have such actual relationship or sequence therebetween. Moreover, the terms, “comprising”, “containing” or any other variants thereof, are intended to cover non-exclusive inclusion, so that a process, method, entity or terminal device comprising a series of elements not only comprises those elements, but also comprises those other elements that are not explicitly listed, or also comprise elements inherent to this process, method, entity, or terminal device. Without more restrictions, the element defined by the sentence “comprising a . . . ” does not exclude the existence of other identical elements in the process, method, entity, or terminal device that comprises the element.

The laser coarse registration method, device, mobile terminal, and storage medium provided by the embodiments of the present application are described in detail above. Specific examples are used in this specification to illustrate the principle and implementation of the present application. The description of the above embodiments is only used to help understand the method and core idea of the present application; and at the same time, as for those ordinarily skilled in the art, according to the idea of the present application, changes are possible in the specific implementation and the usage scope. In summary, the content of this specification should not be construed as a limitation to the present application.

1. A laser coarse registration method, comprising:
determining position information of at least one obstacle around a robot;
converting the position information of the at least one obstacle into an obstacle image;
obtaining map data of a pre-established probability map;
converting the map data into a map image; and
making the obstacle image and the map image subjected to a matching processing through a convolutional neural network, so as to obtain a coarse registration pose of the robot on the map image.

2. The method according to claim 1, wherein the converting the position information of the at least one obstacle into an obstacle image comprises:
performing conversion processing on the position information of the at least one obstacle to obtain pixel values of the obstacle image;
determining at least one point whose pixel value is a first pixel value, as at least one obstacle point on the obstacle image, and determining points, a pixel value of each of which is a second pixel value, as non-obstacle points on the obstacle image; and
marking the at least one obstacle point and the non-obstacle points on the obstacle image.

3. The method according to claim 1, wherein the converting the map data into a map image comprises:
performing a converting processing on the map data according to a preset probability threshold, to obtain pixel values of the map image;
determining at least one point whose pixel value is a first pixel value, as at least obstacle point on the map image, and determining points, a pixel value of each of which is a second pixel value, as non-obstacle points on the map image; and
marking the at least one obstacle point and the non-obstacle points on the map image.

4. The method according to claim 1, wherein the making the obstacle image and the map image subjected to a matching processing through a convolutional neural network so as to obtain a coarse registration pose of the robot on the map image comprises:
inputting respectively the obstacle image and the map image to a laser convolutional neural network LaserCNN layer of the convolutional neural network to be subjected to a convolution matching processing, to obtain a first characteristic matrix and a second characteristic matrix;
inputting the first characteristic matrix and the second characteristic matrix to a pose layer of the convolutional neural network to be subjected to a superposition and flattening processing, to obtain a one-dimensional feature vector; and
performing a full connection processing of three dimensions on the one-dimensional feature vector, to obtain a three-dimensional feature vector, and inputting the obtained three-dimensional feature vector into a full connection layer for being processed, to obtain one three-dimensional feature vector, wherein the one three-dimensional feature vector is the coarse registration pose of the robot on the map image.

5. The method according claim 1, wherein the method further comprises:
using a non-linear optimization registration method to perform precise registration on the coarse registration pose of the robot on the map image, to obtain a precise pose of the robot in the probability map; and
updating the probability map according to the precise pose.

6. The method according to claim 5, wherein the updating the probability map according to the precise pose comprises:
calculating a position of at least one obstacle around the robot on the probability map, according to the precise pose;
judging, according to the position, whether a corresponding point on the probability map is an obstacle point, wherein if yes, a probability value of the corresponding point on the probability map is updated by a preset hit probability value, and if no, a probability value of the corresponding point on the probability map is updated by a preset missing probability value.

7. A laser coarse registration device, comprising:
a first determination module, configured to determine position information of at least one obstacle around a robot; and
a first conversion module, configured to convert the position information of the at least one obstacle into an obstacle image;
an acquisition module, configured to acquire map data of a pre-established probability map;
a second conversion module, configured to convert the map data into a map image; and
a matching processing module, configured to perform a matching processing on the obstacle image and the map image through a convolutional neural network, to obtain a coarse registration pose of the robot on the map image.

8. The device according to claim 7, wherein the device further comprises:
a fine registration processing module, configured to perform precise registration on the coarse registration pose of the robot on the map image by using a non-linear optimization registration method, to obtain a precise pose of the robot in the probability map; and
an update module, configured to update the probability map according to the precise pose.

9. A mobile terminal, comprising: a memory, a processor, and a computer program stored on the memory and capable of running on the processor,
wherein the computer program, when being executed by the processor, realizes steps of the laser coarse registration method according to claim 1.

10. (canceled)

11. The method according to claim 2, wherein the making the obstacle image and the map image subjected to a matching processing through a convolutional neural network so as to obtain a coarse registration pose of the robot on the map image comprises:
inputting respectively the obstacle image and the map image to a laser convolutional neural network LaserCNN layer of the convolutional neural network to be subjected to a convolution matching processing, to obtain a first characteristic matrix and a second characteristic matrix;
inputting the first characteristic matrix and the second characteristic matrix to a pose layer of the convolutional neural network to be subjected to a superposition and flattening processing, to obtain a one-dimensional feature vector; and
performing a full connection processing of three dimensions on the one-dimensional feature vector, to obtain a three-dimensional feature vector, and inputting the obtained three-dimensional feature vector into a full connection layer for being processed, to obtain one three-dimensional feature vector, wherein the one three-dimensional feature vector is the coarse registration pose of the robot on the map image.

12. The method according to claim 3, wherein the making the obstacle image and the map image subjected to a matching processing through a convolutional neural network so as to obtain a coarse registration pose of the robot on the map image comprises:
inputting respectively the obstacle image and the map image to a laser convolutional neural network LaserCNN layer of the convolutional neural network to be subjected to a convolution matching processing, to obtain a first characteristic matrix and a second characteristic matrix;
inputting the first characteristic matrix and the second characteristic matrix to a pose layer of the convolutional neural network to be subjected to a superposition and flattening processing, to obtain a one-dimensional feature vector; and
performing a full connection processing of three dimensions on the one-dimensional feature vector, to obtain a three-dimensional feature vector, and inputting the obtained three-dimensional feature vector into a full connection layer for being processed, to obtain one three-dimensional feature vector, wherein the one three-dimensional feature vector is the coarse registration pose of the robot on the map image.

13. The method according to claim 2, wherein the method further comprises:
using a non-linear optimization registration method to perform precise registration on the coarse registration pose of the robot on the map image, to obtain a precise pose of the robot in the probability map; and
updating the probability map according to the precise pose.

14. The method according to claim 3, wherein the method further comprises:
using a non-linear optimization registration method to perform precise registration on the coarse registration pose of the robot on the map image, to obtain a precise pose of the robot in the probability map; and
updating the probability map according to the precise pose.
